(19) United States
(12) Patent Application Publication
(10) Pub. No.: US 2024/0018755 A1
(43) Pub. Date: Jan. 18, 2024

(54) A WATER RECIRCULATION SYSTEM INTENDED FOR RECYCLING OF WATER OR DISCARDING OF WATER NOT SUITABLE TO RECYCLE

(71) Applicant: Orbital Systems AB, MALMÖ (SE)

(72) Inventors: Mårten ÖBRINK, MALMÖ (SE); Michael RIDELL, STAFFANSTORP (SE); Mikael NILSSON, TRELLEBORG (SE)

(73) Assignee: Orbital Systems AB, MALMÖ (SE)

(21) Appl. No.: 18/252,749

(22) PCT Filed: Nov. 12, 2021
(86) PCT No.: PCT/SE2021/051133

§ 371 Date: May 12, 2023

(30) Foreign Application Priority Data
Nov. 18, 2020 (SE) 2051345-3

(51) Int. Cl. E03B 1/04; C02F 1/32

(52) U.S. Cl. CPC E03B 1/041; C02F 1/32; C02F 2103/002

(57) ABSTRACT

The present invention describes a water recirculation system 1 intended for recycling of water or discarding of water not suitable to recycle, said water recirculation system 1 comprising a heating unit 2 with one cold-side space 3 intended for a water flow in the water recirculation system 1 to be heated and one hot-side space 4 arranged to provide a heating fluid which indirectly heats said water flow in the cold-side space 3, said hot-side space 4 being connected to any of the following:
a reservoir comprising hot glycol or a hot water/glycol mixture; and/or
one side of a heat-exchanger arrangement with water on one side and glycol or a water/glycol mixture on the other side.

### FIELD OF THE INVENTION

The present invention relates to a water recirculation system intended for recycling of water or discarding of water not suitable to recycle.

### SUMMARY OF THE INVENTION

The present invention is directed to a water recirculation system intended for recycling of water or discarding of water not suitable to recycle, said water recirculation system comprising a heating unit with one cold-side space intended for a water flow in the water recirculation system to be heated and one hot-side space arranged to provide a heating fluid which indirectly heats said water flow in the cold-side space, said hot-side space being connected to any of the following:
a reservoir comprising hot glycol or a hot water/glycol mixture; and/or
one side of a heat-exchanger arrangement with water on one side and glycol or a water/glycol mixture on the other side.

In WO 2020/112001 there is disclosed a water recirculation system intended for recycling of water or discarding of water not suitable to recycle, said water recirculation system comprising a flow path for recirculation, at least one water treating unit, and a sensor unit arranged for measurement of at least water quality, and wherein the sensor unit is connected to a control unit which decides if water should be recycled or discarded in a point of separation based on the measurement of the water quality, said water recirculation system also comprising a first heating source and a second heating source.

The present invention is totally directed to a water recirculation system in which glycol plays a key role to provide for the heating solution in the water recirculation system. Glycol is not described, intended or even mentioned in WO 2020/112001.

### SPECIFIC EMBODIMENTS OF THE INVENTION

Specific embodiments of the present invention will become clear from the appended claims and is further discussed below.

According to one embodiment of the present invention, the heating unit is a heat-exchanger.

According to one specific embodiment of the present invention, the hot-side space is a heating coil. Moreover, according to yet another embodiment, the hot-side space is a heating coil connected to a reservoir comprising hot glycol or a hot water/glycol mixture.

Furthermore, according to yet another embodiment of the present invention, the hot-side space is a heating coil connected to one side of a heat-exchanger arrangement with water on one side and glycol or a water/glycol mixture on the other side.

According to yet another embodiment of the present invention, the water recirculation system comprises a flow path for recirculation, at least one water treating unit, and a sensor unit arranged for measurement of at least water quality, and wherein the sensor unit is connected to a control unit which decides if water should be recycled or discarded in a point of separation based on the measurement of the water quality.

Suitably, the point of separation is arranged in a drain. Furthermore, according to one embodiment, the heating unit is arranged in connection with said at least one water treating unit.

According to yet another embodiment of the present invention, the water recirculation system comprises one additional heating source. Furthermore, according to yet another embodiment, the additional heating source is connected to the heating unit to enable heating of the water flow in the cold-side space.

### DRAWINGS

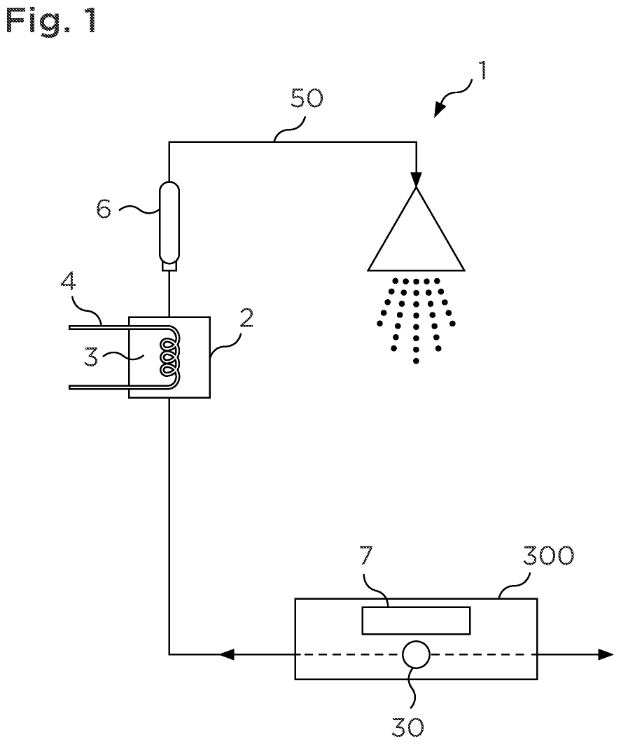

One specific embodiment of the present invention is shown in FIG. 1. The water recirculation system 1 intended for recycling of water or discarding of water not suitable to recycle comprises a heating unit 2 with one cold-side space 3 intended for a water flow in the water recirculation system 1 to be heated and one hot-side space 4 arranged to provide a heating fluid which indirectly heats said water flow in the cold-side space 3. The hot-side space 4 is connected to a reservoir comprising hot glycol or a hot water/glycol mixture and/or one side of a heat-exchanger arrangement with water on one side and glycol or a water/glycol mixture on the other side.

Moreover, the water recirculation system 1 comprises a flow path for recirculation 50, at least one water treating unit 6, and a sensor unit 7 arranged for measurement of at least water quality. The sensor unit 7 is connected to a control unit which decides if water should be recycled or discarded in a point of separation 30 based on the measurement of the water quality. Furthermore, in this case the point of separation 30 is arranged in a drain 300.

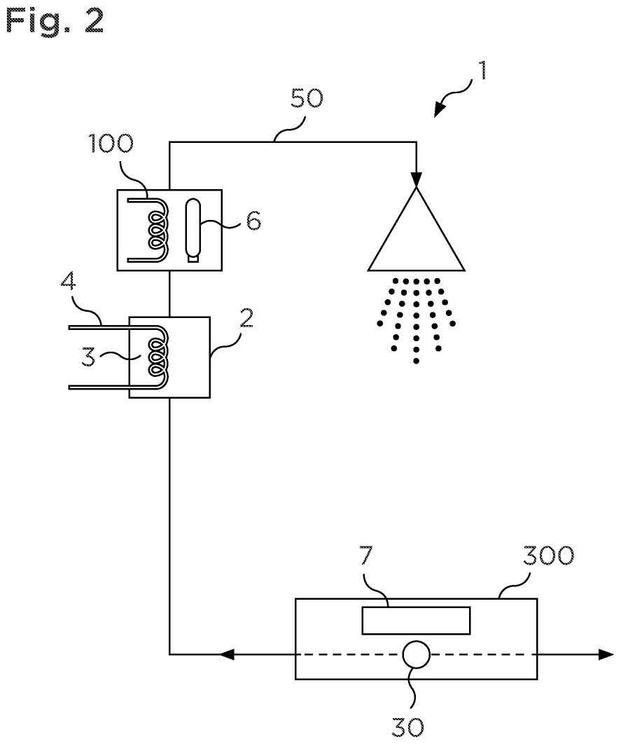

Another embodiment is shown in FIG. 2, similar to the one shown in FIG. 1. In this case, there is arranged a combined UV/heater unit shown as the arrangement with a UV lamp (water treating unit) 6 and one additional heating source 100.

1. A water recirculation system intended for recycling of water or discarding of water not suitable to recycle, said water recirculation system comprising a heating unit with one cold-side space intended for a water flow in the water recirculation system to be heated and one hot-side space arranged to provide a heating fluid which indirectly heats said water flow in the cold-side space, said hot-side space being connected to any of the following:
a reservoir comprising hot glycol or a hot water/glycol mixture; and/or
one side of a heat-exchanger arrangement with water on one side and glycol or a water/glycol mixture on the other side.

2. The water recirculation system according to claim 1, wherein the heating unit is a heat-exchanger.

3. The water recirculation system according to claim 1, wherein the hot-side space is a heating coil.

4. The water recirculation system according to claim 3, wherein the hot-side space is a heating coil connected to a reservoir comprising hot glycol or a hot water/glycol mixture.

5. The water recirculation system according to claim 3, wherein the hot-side space is a heating coil connected to one side of a heat-exchanger arrangement with water on one side and glycol or a water/glycol mixture on the other side.

6. The water recirculation system according to claim 1, wherein the water recirculation system comprises a flow path for recirculation, at least one water treating unit, and a sensor unit arranged for measurement of at least water quality, and wherein the sensor unit is connected to a control unit which decides if water should be recycled or discarded in a point of separation based on the measurement of the water quality.

7. The water recirculation system according to claim 6, wherein the point of separation is arranged in a drain.

8. The water recirculation system according to claim 6, wherein the heating unit is arranged in connection with said at least one water treating unit.

9. The water recirculation system according to claim 1, wherein the water recirculation system comprises one additional heating source.

10. The water recirculation system according to claim 1, wherein the additional heating source is connected to the heating unit to enable heating of the water flow in the cold-side space.
